(19) United States
(12) Patent Application Publication
(10) Pub. No.: US 2017/0242209 A1
(43) Pub. Date: Aug. 24, 2017

(54) OPTICAL FIBER AND OPTICAL FIBER RIBBON

(71) Applicant: SUMITOMO ELECTRIC INDUSTRIES, LTD., Osaka-shi, Osaka (JP)

(72) Inventors: Kumiko TACHIBANA, Yokohama-shi (JP); Takashi FUJII, Yokohama-shi (JP)

(73) Assignee: SUMITOMO ELECTRIC INDUSTRIES, LTD., Osaka-shi, Osaka (JP)

(21) Appl. No.: 15/519,195

(22) PCT Filed: Oct. 17, 2014
(86) PCT No.: PCT/JP2014/077717

§ 371 Date: Apr. 14, 2017

(51) Int. Cl. G02B 6/44; G02B 6/02; G02B 6/036

(52) U.S. Cl. CPC G02B 6/4403; G02B 6/036; G02B 6/02009

(57) ABSTRACT

There is provided an optical fiber in which no color peeling occurs at the time of separation into a single optical fiber from an optical fiber ribbon and a resin coating layer is sufficiently cured. An optical fiber comprises a glass fiber and a resin coating layer that covers the outer periphery of the glass fiber, wherein the resin coating layer has a colored layer having a thickness of 10 μm or more and 0.06 to 1.8% by mass of titanium element is contained in the resin coating layer, and an optical fiber ribbon comprises a plurality of the optical fibers arranged in parallel, the plurality of the optical fibers being connected by a connecting material.

### TECHNICAL FIELD

The present invention relates to an optical fiber and an optical fiber ribbon.

### BACKGROUND ART

Patent Document 1 describes a “colored optical fiber” wherein a glass fiber is coated with a primary layer and a secondary layer composed of an ultraviolet curable resin or the like and a colored layer is further formed on the outer periphery thereof using a specific ultraviolet curable ink.

Moreover, Patent Document 2 describes a colored optical fiber having two coating layers of a primary coating layer and a secondary coating layer, wherein either of the primary coating layer and the secondary coating layer is colored.

### BACKGROUND ART DOCUMENTS

### Patent Documents

Patent Document 1: JP-A-2005-165227

Patent Document 2: JP-A-2013-167762

### SUMMARY OF THE INVENTION

### Problem to be Solved

However, when a thin colored layer (ink layer) is provided on the outermost layer of an optical fiber as in Patent Document 1, an optical fiber ribbon using the optical fiber has a problem that the ink layer may be peeled from the optical fiber (so-called color peeling) at the operation of stripping a ribbon material to take out the optical fiber. In order to prevent the color peeling, it has been considered to color the resin coating layer (the primary layer or the secondary layer) without the ink layer.

However, as compared with the conventional optical fiber which is coated with a thin ink layer having a thickness of about 5 μm in a coloring step after the primary layer and the secondary layer are sufficiently cured in a drawing step, in the optical fiber coated with a resin coating layer containing a colored layer having a thickness of 10 μm or more, insufficient curing of the resin coating layer tends to occur.

An object of the present invention is to provide an optical fiber in which no color peeling occurs at the time of separation into a single optical fiber from an optical fiber ribbon and a resin coating layer is sufficiently cured.

### Means for Solving the Problem

The optical fiber according to one embodiment of the present invention is an optical fiber comprising a glass fiber and a resin coating layer that covers the outer periphery of the glass fiber, wherein

the resin coating layer has a colored layer having a thickness of 10 μm or more and 0.06 to 1.8% by mass of titanium element is contained in the resin coating layer.

The optical fiber ribbon according to another embodiment of the invention is an optical fiber ribbon comprising a plurality of the above-described optical fibers arranged in parallel, the plurality of the optical fibers being connected with a connecting material.

### Advantage of the Invention

According to the present invention, it becomes possible to obtain an optical fiber in which no color peeling occurs at the time of separation into a single optical fiber from an optical fiber ribbon and a resin coating layer is sufficiently cured.

### BRIEF DESCRIPTION OF THE DRAWINGS

FIG. 1 is a schematic cross-sectional view showing an example of an optical fiber of the present invention.

FIG. 2 is a schematic cross-sectional view showing an example of an optical fiber ribbon of the present invention.

### DETAILED DESCRIPTION OF EMBODIMENTS

The optical fiber according to one embodiment of the present invention is (1) an optical fiber comprising a glass fiber and a resin coating layer that covers the outer periphery of the glass fiber, wherein

the resin coating layer has a colored layer having a thickness of 10 μm or more and 0.06 to 1.8% by mass of titanium element is contained in the resin coating layer.

The resin coating layer of the optical fiber is usually formed of an ultraviolet curable resin composition. In the case where the resin coating layer is a colored layer, an ultraviolet curable resin composition added with a coloring pigment is applied on the outer periphery of the glass fiber and then irradiation with ultraviolet rays is performed to cure the ultraviolet curable resin composition.

However, when a pigment that absorbs applied ultraviolet rays is present in the ultraviolet curable resin composition, curing of the resin coating layer becomes insufficient.

In the present embodiment, titanium oxide is incorporated into the resin coating layer and the content thereof is controlled to 0.1 to 3.0% by mass, thereby preventing insufficient curing of the resin coating layer.

It is surmised that the reason is that titanium oxide in the resin coating layer scatters the applied ultraviolet rays and therefore the ultraviolet rays also reach portions which may be difficult for the rays to reach in the case where titanium oxide is not present.

Moreover, when the colored layer has a thickness of 10 μm or more, color peeling does not occur even in the case where the colored layer is provided as the outermost layer of the resin coating layer.

(2) In the above-described optical fiber, the resin coating layer is formed of an ultraviolet curable resin composition and gel fraction is more than 75% by mass. Thereby, good pullout force (force when the resin coating layer is pulled out with leaving the glass fiber) and ribbon simultaneous removability are obtained.

(3) In the above-described optical fiber, the amount of unreacted photoinitiator in the resin coating layer is 3% by mass or less. Thereby, an increase in attenuation at low temperature can be prevented.

(4) In the above-described optical fiber, it is preferred that the resin coating layer includes an inner layer that coats the outer periphery of the glass fiber and an outer layer that coats the inner layer and Young's modulus of the inner layer is 0.05 to 1 MPa. This is because good resistance of lateral pressure are obtained, the aforementioned pullout force falls within a proper range, and residue of the resin coating layer does not remain on the glass in the ribbon simultaneous stripping.

(5) Moreover, the optical fiber of the present embodiment can be converted into an optical fiber ribbon comprising a plurality of the optical fibers arranged in parallel, the plurality of the optical fibers being connected with a connecting material.

### DETAILS OF EMBODIMENT OF THE INVENTION

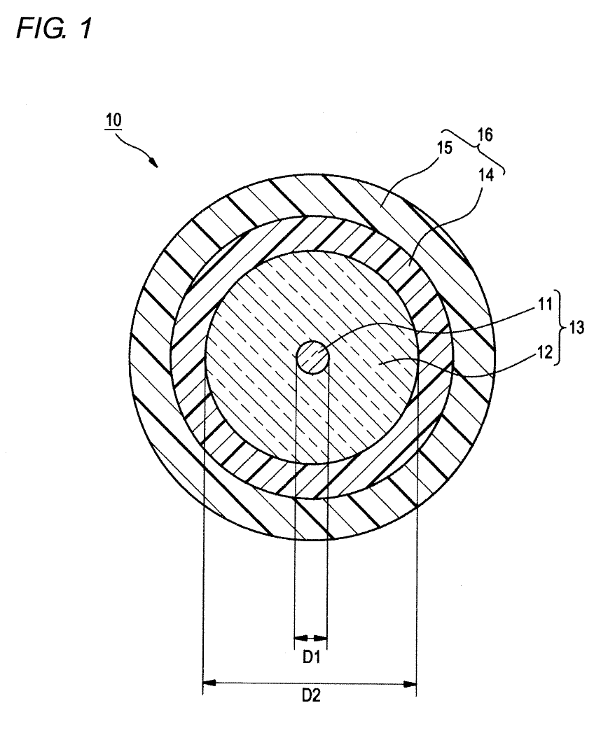

The following will describe the embodiment of the present invention in detail with reference to FIG. 1.

### (Summary of Optical Fiber)

FIG. 1 is a schematic cross-sectional view showing an example of an optical fiber that is one mode of the present invention.

An optical fiber 10 has a resin coating layer 16 including an inner layer 14 and an outer layer 15 which are each formed of an ultraviolet curable resin composition (hereinafter also simply referred to as “resin composition”). Incidentally, the glass fiber 13 is composed of a core part 11 and a cladding part 12. For example, silica added with germanium can be used as the core part 11 and pure silica or silica added with fluorine can be used as the cladding part 12.

In FIG. 1, for example, the diameter of the glass fiber 13 is about 125 μm. The resin coating layer 16 may be constituted by one layer alone or a plurality of layers. Preferably, it is composed of two layers of the inner layer 14 and the outer layer 15. The total thickness of the resin coating layer 16 is usually 60 to 70 μm, preferably 70 μm or less, and more preferably 65 μm. The thickness of each of the inner layer 14 and the outer layer 15 is sufficiently 10 to 50 μm and the thickness of the inner layer 14 and the thickness of the outer layer 15 may be about the same. The outer diameter of the optical fiber 10 is 245 to 265 μm, and preferably 255 mm. In the case where the resin coating layer is one layer alone, the thickness of the resin coating layer is preferably 60 μm to 70 μm.

The content of the titanium element in the whole layer of the resin coating layer 16 is 0.06 to 1.8% by mass, and preferably 0.12 to 0.90% by mass. The titanium element is derived from titanium oxide and it is preferred that, when converted into the amount of titanium oxide, the amount is 0.1 to 3% by mass, and preferably 0.2 to 1.5% by mass. When the content of the titanium element is less than 0.06%, the degree of curing of the resin coating layer decreases (decreasing to 75% by mass or less as gel fraction). Moreover, in the case where titanium oxide is used alone as a white pigment in order to make the colored layer white, when the content of the titanium element is less than 0.06%, white color becomes thin and color distinction by the naked eye becomes difficult. When the content of the titanium element exceeds 1.8%, it is difficult to disperse the titanium element into the colored layer homogeneously and color unevenness is generated to result in defective appearance.

The colored layer containing titanium oxide may be either of the inner layer 14 and the outer layer 15. Moreover, both of the inner layer 14 and the outer layer 15 may be the colored layer containing titanium oxide. From the viewpoint of improving discrimination ability of the optical fiber 10, it is preferred that the outer layer 15 is the colored layer. In the optical fiber 10 of the embodiment shown in FIG. 1, the resin coating layer 16 is composed of two layers of the inner layer 14 and the outer layer 15 but may have an overcoat layer other than the inner layer 14 and the outer layer 15 outer layer 15. Moreover, the overcoat layer may be the colored layer containing titanium oxide or all of the inner layer 14, the outer layer 15, and the overcoat layer may be the colored layer containing titanium oxide. Furthermore, the resin coating layer 16 may be composed of only one layer and, in this case, the resin coating layer 16 composed of only one layer is the colored layer containing titanium oxide. In any cases, the content of the titanium element in the invention is shown as the mass of the titanium element relative to the mass of the whole layer of the coating layer.

The content of the titanium element of the resin coating layer 16 can be determined by high-frequency inductively coupled plasma (ICP) measurement.

The thickness of the colored layer is 10 μm or more, preferably 10 to 70 μm, more preferably 10 to 50 μm, and further preferably 20 to 40 μm. When the thickness of the colored layer is 10 μm or more, the color peeling can be suppressed.

The thickness of the inner layer 14 is usually about 20 to 50 μm and, in the case where the inner layer 14 is the colored layer, the thickness of the inner layer 14 is the thickness of the colored layer. The thickness of the outer layer 15 is usually about 20 to 50 μm and, in the case where the outer layer 15 is the colored layer, the thickness of the outer layer 15 is the thickness of the colored layer.

The Young's modulus of the inner layer 14 is preferably 1 MPa or less, and more preferably 0.5 MPa or less. The Young's modulus of the outer layer 15 is preferably 600 to 1000 MPa.

### (Base Resin)

In the present embodiment, the resin composition that forms the above-described resin coating layer contains the following base resin.

The base resin is not particularly limited as long as it has ultraviolet curability but, for example, is preferably one containing an oligomer, a monomer, and a photoinitiator.

Examples of the oligomer include urethane (meth)acrylates, epoxy (meth)acrylates, or mixed compound thereof.

Examples of the urethane acrylates include those obtained by reacting a polyol compound, a polyisocyanate compound, and a hydroxyl group-containing acrylate compound.

Examples of the polyol compound include polytetramethylene glycol, polypropylene glycol, bisphenol A-ethylene oxide added diol, and the like. Examples of the polyisocyanate compound include 2,4-tolylene diisocyanate, 2,6-tolylene diisocyanate, isophorone diisocyanate, and the like. The hydroxyl group-containing acrylate compound includes 2-hydroxy (meth)acrylate, 2-hydroxybutyl (meth)acrylate, 1,6-hexanediol mono(meth)acrylate, pentaerythritol tri(meth)acrylate, 2-hydroxypropyl (meth)acrylate, tripropylene glycol di(meth)acrylate, and the like. As the epoxy (meth)acrylate, for example, there can be used one obtained by reacting an epoxy compound and (meth)acrylic acid. Here, (meth)acrylate means acrylate or methacrylate corresponding thereto. The same shall apply to (meth)acrylic acid.

The content of the oligomer is preferably 50 to 90% by mass, and more preferably 35 to 85% by mass on the basis of the total amount of the ultraviolet curable resin composition.

Examples of the monomer include N-vinyl monomers having a cyclic structure, e.g., N-vinylpyrrolidone, N-vinylcaprolactam, and (meth)acryloylmorpholine. When these monomers are contained, the curing rate is improved and thus the case is preferred. In addition to the above, there may be used a monofunctional monomer such as isobornyl (meth)acrylate, tricyclodecanyl (meth)acrylate, benzyl (meth)acrylate, dicyclopentanyl (meth)acrylate, 2-hydroxyethyl (meth)acrylate, nonylphenyl (meth)acrylate, phenoxyethyl (meth)acrylate, or polypropylene glycol mono(meth)acrylate; or a polyfunctional monomer such as polyethylene glycol di(meth)acrylate, tricyclodecanediyldimethylene di(meth)acrylate, bisphenol A-ethylene oxide added diol di(meth)acrylate, or trimethylolpropane tri(meth)acrylate.

The monomers may be used as a mixture of two or more thereof. The content of the monomer is preferably 5 to 45% by mass, and more preferably 10 to 30% by mass on the basis of the total amount of the ultraviolet curable resin composition.

As the photoinitiator, a radical photopolymerization initiator can be used and, for example, an acylphosphine oxide-based initiator and an acetophenone-based initiator may be mentioned.

The acetophenone-based initiator includes 1-hydroxycyclohexan-1-yl phenyl ketone (trade name “Irgacure 184” manufactured by BASF), 2-hydroxy-2-methyl-1-penyl-propan-1-one (trade name “Darocur 1173” manufactured by BASF), 2,2-dimethoxy-1,2-diphenylethan-1-one (trade name “Irgacure 651” manufactured by BASF), 2-methyl-1-(4-methylthiophenyl)-2-morpholinopropan-1-one (trade name “Irgacure 907” manufactured by BASF), 2-benzyl-2-dimethylamino-1-(4-morpholinophenyl)-butanone-1 (trade name “Irgacure 369” manufactured by BASF), 1-hydroxycyclohexyl phenyl ketone, 2,2-dimethoxy-2-phenylacetophenone, 1-(4-isopropylphenyl)-2-hydroxy-2-methylpropan-1-one, and the like.

The acylphosphine oxide-based initiator includes 2,4,6-trimethylbenzoyldiphenylphosphine oxide (trade name “Lucirin TPO” manufactured by BASF), 2,4,4-trimethylpentylphosphine oxide, 2,4,4-trimethylbenzoyldiphenylphosphinoxide, and the like.

The photoinitiators may be used as a mixture of two or more thereof. The content of the photoinitiator is preferably 0.1 to 10% by mass, and more preferably 0.3 to 7% by mass on the basis of the total amount of the ultraviolet curable resin composition.

### (Other Components)

The above-described resin composition may contain a silane coupling agent, an antioxidant, a photosensitizer, and the like.

In the present embodiment, in order to form the colored layer containing titanium oxide, titanium oxide is added to the resin composition in a predetermined amount. The content of the titanium element in the resin coating layer 16 is preferably 0.06 to 1.8% by mass, and more preferably 0.12 to 0.90% by mass. In terms of the amount of titanium oxide, it is preferably 0.1 to 3.0% by mass, and further preferably 0.2 to 1.5% by mass.

### (Other Characteristics)

In the present embodiment, the gel fraction of the resin coating layer 16 is more than 75% by mass and the amount of the unreacted photoinitiator in the resin coating layer 16 is 3% by mass or less.

Moreover, in the case where the resin coating layer 16 is composed of two layers of the inner layer 14 and the outer layer 15, the Young's modulus of the inner layer 14 is preferably 0.05 to 1 MPa.

### (Manufacture of Optical Fiber)

The optical fiber 10 of the present embodiment can be manufactured by applying the above-described resin composition on the outer periphery of the glass fiber 13, then performing ultraviolet irradiation to cure the applied resin composition, and thus forming the resin coating layer 16. On this occasion, there may be adopted a wet-on-dry method in which a resin composition for forming the inner layer 14 is applied on the outer periphery of the glass fiber 13 and cured and then a resin composition for forming the outer layer 15 is applied on the outer periphery thereof and cured. Moreover, there may be adopted a wet-on-wet method in which a resin composition for forming the inner layer 14 is applied on the outer periphery of the glass fiber 13, then a resin composition for forming the outer layer 15 is applied on the outer periphery thereof, and the inner layer 14 and the outer layer 15 are simultaneously cured.

### (Mode as Optical Fiber Ribbon)

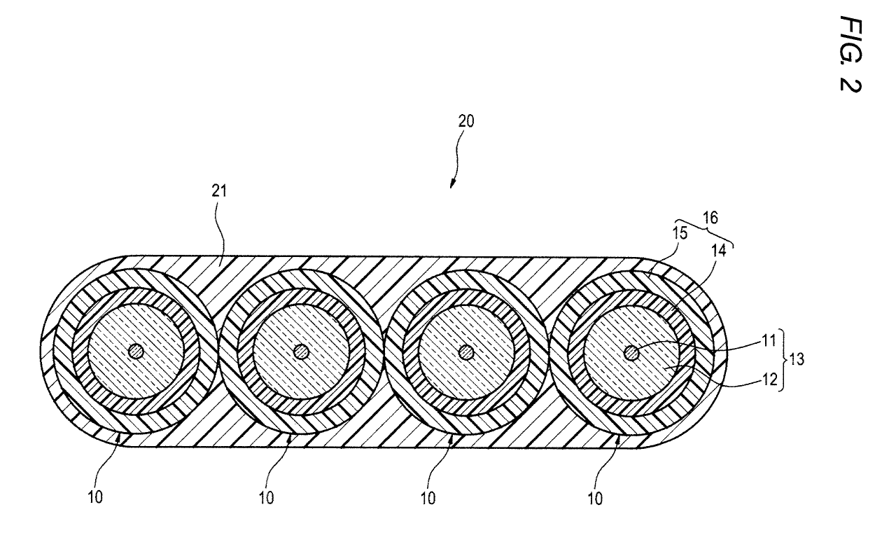

As shown in FIG. 2, the optical fiber 10 of the above-described embodiment can be gathered to an optical fiber ribbon 20 comprising a plurality of the optical fibers 10 arranged in parallel, the plurality of the optical fibers 10 being connected with a connecting material 21. By the conversion into the optical fiber ribbon 20, the color peeling-suppressing effect of the optical fiber 10 of the embodiment can be suitably exhibited.

As the connecting material 21 for the optical fiber ribbon 20, from the viewpoints of damage prevention, dividing easiness and the like of the optical fiber 10, suitable are thermosetting resins such as silicone resins, epoxy resins, and urethane resins and ultraviolet curable resins such as epoxy acrylate resins, urethane acrylate resins, and polyester acrylate resins. Of these, preferred are ultraviolet curable resins such as epoxy acrylate resins, urethane acrylate resins, and polyester acrylate resins, and more preferred are urethane acrylate resins.

A curable resin composition that forms the connecting material 21 can contain a polymerizable monomer and/or a polymerizable oligomer that is a constitutional component of the resin. Examples of the polymerizable oligomer include a urethane acrylate obtained by reacting bisphenol A-ethylene oxide added diol, tolylene diisocyanate, and hydroxyethyl acrylate; a urethane acrylate obtained by reacting polytetramethylene glycol, tolylene diisocyanate, and hydroxyethyl acrylate; a urethane acrylate obtained by reacting tolylene diisocyanate and hydroxyethyl acrylate; and the like.

Moreover, examples of the polymerizable monomer include tricyclodecane diacrylate; N-vinylpyrrolidone; isobornyl acrylate; bisphenol A-ethylene oxide added diacrylate; bisphenol A-epoxy diacrylate; ethylene oxide-added nonylphenol acrylate; and the like. These constitutional components may be used singly or two or more thereof may be used in combination. In addition, a polysiloxane compound can be used with adding it to the constitutional component.

Furthermore, a photopolymerization initiator can be blended into the curable resin composition for the connecting material 21. The photopolymerization initiator is not particularly limited but it is preferred to blend 2-methyl-1-[4-(methylthio)phenyl]-2-morpholino-propan-1-one and 2,4,6-trimethylbenzoyldiphenylphosphine oxide.

### EXAMPLES

Hereinafter, the present invention will be described further in detail with showing the results of evaluation tests using Examples according to the invention and Comparative Examples. Incidentally, the present invention is not intended to be limited to the following examples.

### [Production of Optical Fiber 10]

As the glass fiber 13, there was used one composed of a core 11 and a cladding 12 and having an outer diameter of 125 μm. The outer periphery of the glass fiber 13 was coated with two layers (inner layer 14 and outer layer 15 ) by curing a resin composition for the inner layer and a resin composition for the outer layer to form a resin coating layer, thereby producing an optical fiber 10. A colored layer was the outermost layer and had the thickness shown in Table 1. The diameter of the optical fiber was 255 μm. The linear velocity at the time of manufacturing the optical fiber was controlled to be the linear velocity shown in Table 1 in each example.

TABLE 1
(Resin Composition for Inner Layer)

| | | |
|---|---|---|
| A urethane acrylate oligomer obtained by reacting | 75 | parts by mass |
| polypropylene glycol having a number-average | | |
| molecular weight of 3,000 with 2,4-tolylene | | |
| diisocyanate and 2-hydroxyethyl acrylate | | |
| N-vinylcaprolactam | 10 | parts by mass |
| 2,4,6-Trimethylbenzoyldiphenylphosphine oxide | 3 | parts by mass |
| (photoinitiator) | | |
| Silane coupling agent | 1 | part by mass |

The urethane acrylate oligomer was each of the following blend
examples a to d and the others were a common blend.

| | | |
|---|---|---|
| Blend Example a | | |
| One-terminal non-reactive oligomer | 20% | by mass |
| Both-terminal reactive oligomer | 80% | by mass |
| Blend Example b | | |
| One-temiinal non-reactive oligomer | 40% | by mass |
| Both-terminal reactive oligomer | 60% | by mass |
| Blend Example c | | |
| One-terminal non-reactive oligomer | 100% | by mass |
| Both-terminal reactive oligomer | 0% | by mass |
| Blend Example d | | |
| One-terminal non-reactive oligomer | 0% | by mass |
| Both-terminal reactive oligomer | 100% | by mass |

The structure of the one-terminal non-reactive oligomer and the
structure of the both-terminal reactive oligomer are as follows.
One-terminal reactive oligomer:
H-T-Polypropylene Glycol-T-MeOH
Both-terminal reactive oligomer:
H-T-Polypropylene Glycol-T-H

In the notation of the oligomers, H represents a residual group of 2-hydroxyethyl acrylate, T represents a residual group of 2,4-tolylene diisocyanate, MeOH represents a residual group of methanol, and Polypropylene Glycol represents a residual group of polypropylene glycol.

TABLE 2
(Resin Composition for Outer Layer)

| | |
|---|---|
| A urethane acrylate oligomer obtained by | 75 parts by mass |
| reacting polypropylene glycol having a | |
| number-average molecular weight of | |
| 1,000 with 2,4-tolylene diisocyanate | |
| and 2-hydroxyethyl acrylate | |
| Bisphenol A-ethylene oxide added diol | 10 parts by mass |
| diacrylate | |
| 1-Hydroxycyclohexan-1-yl phenyl | 3 parts by mass |
| ketone (Irgacure 184, photoinitiator) | |
| Titanium oxide | a blending amount so as to be a titanium content |
| | (% by mass) shown in the following Table 1 in |
| | the whole layer of the resin coating layer 16 |
| Copper phthalocyanine (coloring agent) | a blending amount so as to be 0.2% by mass in |
| | the whole layer of the resin coating layer 16 |

In the case where the coating layer was composed of three layers, the above-described resin composition for the outer layer was used for the second layer and the third layer from the inside and titanium oxide and copper phthalocyanine were only added to the third layer (outermost layer).

### [Evaluation of Optical Fiber 10]

For the produced optical fiber 10, the following evaluation tests (the content of titanium in the whole layer of the resin coating layer 16, the amount of the unreacted photoinitiator in the whole layer of the resin coating layer 16, the Young's modulus of the inner layer 14, the value of pullout force of the resin coating layer 16, the gel fraction of the resin coating layer 16, lateral pressure resistance, and an increase in attenuation at low temperature) were performed, and for the optical fiber ribbon 20, the following evaluation tests (color peeling and ribbon simultaneous removability) were performed. The results are shown in the following Table 1.

### (Content of Titanium in Whole Layer of Resin Coating Layer 16)

After 10 ml of sulfuric acid and 5 ml of nitric acid were added to 0.2 g of the optical fiber (coating resin: 0.12 g) to generate white smoke and the whole was heated for 10 minutes, 1 ml of perchloric acid was added thereto and the whole was heated until insoluble matter disappeared, thereby preparing a measurement sample. For the measurement sample, the amount of the titanium element was measured by high-frequency inductively coupled plasma (ICP).

### (Amount of Unreacted Photoinitiator in Whole Layer of Resin Coating Layer 16)

The optical fiber whose weight had been measured beforehand was subjected to Soxhlet extraction (120° C.×1 hour) with acetone to extract the unreacted initiator that remained in the resin coating layer. Then, the amount of the unreacted initiator extracted into acetone was measured using GCMS.

### (Young's Modulus of Inner Layer 14)

It was measured by a Pullout Modulus (POM) method. Two places of the optical fiber 10 were fixed with two chuck devices, the resin-coated portion between the two chuck devices were striped, then one chuck device was fixed, and another chuck device was slowly moved to a direction reverse to the fixed chuck device. When the length of the portion that was pinched with the chuck device to be moved in the optical fiber 10 is taken as L, the moving amount of the chuck is taken as Z, the outer diameter of the inner layer 14 is taken as Dp, the outer diameter of the glass fiber 13 is taken as Df, the Poisson ratio of the inner layer 14 is taken as n, the load of the chuck device at the movement is taken as W, the Young's modulus (POM value) of the inner layer 14 was determined from the following expression.

Young's modulus (Pa)=((1+n)W/πLZ)×ln(Dp/Df)

### (Value of Pullout Force of Resin Coating Layer 16)

A cut line was made into the resin coating layer of the optical fiber 10 with a razor at a depth so that the cutting edge did not reach the surface of the glass fiber 13, one side of the resin coating layer beyond the cut line was adhered to a mount and fixed to the mount, and the other side of the coated optical fiber was held and pulled. A pullout force was measured at the time of pulling out the part of the glass fiber 13 from the resin coating layer fixed to the mount. One showing a pullout force of 2.0 kg or less and more than 1.5 kg is rated as A, one showing a pullout force of 1.5 kg or less and 0.5 kg or more is rated as B, one showing a pullout force of less than 0.5 kg and 0.3 kg or more is rated as C, one showing a pullout force of more than 2.0 kg is rated as D, and one showing a pullout force of less than 0.3 kg is rated as E.

### (Gel Fraction of Resin Coating Layer 16)

After the optical fiber 10 was immersed in methyl ethyl ketone (MEK) at 60° C. for 17 hours, it was dried at 100° C. for 2 hours and subsequently was naturally cooled to ordinary temperature and the weight was measured. From the weight before MEK immersion and the weight after MEK immersion, the gel fraction was determined according to the following expression.

(Coating weight after MEK immersion and drying/Coating weight before MEK immersion)×100=Gel fraction

### (Lateral Pressure Resistance)

The optical fiber 10 to be tested was wound in a single layer state on a bobbin having a diameter of 280 mm whose surface was covered with sandpaper and on a bobbin having the same diameter without sandpaper and transmission loss of a light having a wavelength of 1550 nm was measured by an OTDR (Optical Time Domain Reflectometer) method.

Incidentally, as the optical fiber 10 to be tested, a single mode optical fiber conforming to G652 and having an MFD1 (mode field diameter) of 10.4 μm was used.

Using the measured loss, for Δα calculated from the expression:

Δα (dB/km)=Loss (with sandpaper)−Loss (without sandpaper),

evaluation was performed according to the following criteria.
Δα≦0.3 dB/km: A, 0.3<Δα≦0.6 dB/km: B, Δα>0.6 dB/km: C

### (Ribbon Simultaneous Removability)

The connecting material 21 and the resin coating layer 16 were simultaneously stripped with a jacket remover JR-6 manufactured by Sumitomo Electric Industries, Ltd. to expose the glass fiber 13. The case where the residue of the coating resin is not observed on the surface of the glass fiber 13 is rated as A and the case where it is observed thereon is rated as B.

### (Increase in Attenuation at Low Temperature)

Transmission loss for the optical fiber 10 to which a screening tension of 2 kg was applied was measured and, after the optical fiber 10 was placed at −40° C. for 2 hours, transmission loss was measured. An increase in the transmission loss of a light having a wavelength of 1550 nm for one placed at −40° C. as compared with one before placed at −40° C. was determined. The case where the increase in the transmission loss exceeds 0.03 dB/km is rated as B and the case where it is 0.03 dB/km or less is rated as A.

### (Color Peeling)

After the optical fiber ribbon 20 was deteriorated under environments of 85° C. and 85% RH (dark place) for 30 days, the optical fiber 10 was obtained by separation into a single optical fiber in accordance with Telcordia GR-20 5.3.1 from the optical fiber ribbon 20. The presence of peeling of the colored layer and the ink layer on this occasion was evaluated, and the case of the absence of peeling is rated as A and the case of the presence of peeling is rated as B.

Four optical fibers 10 were prepared and a four-fiber type optical fiber ribbon was manufactured using a resin composition for the connecting material 21 having the following composition.

TABLE 3
(Resin Composition for Connecting Material 21)

| | |
|---|---|
| A urethane acrylate obtained by reacting 1 mol of | 18 parts by mass |
| bisphenol A-ethylene oxide added diol, 2 mol of | |
| tolylene diisocyanate, and 2 mol of hydroxyethyl | |
| acrylate | |
| A urethane acrylate obtained by reacting 1 mol of | 10 parts by mass |
| polytetramethylene glycol, 2 mol of tolylene | |
| diisocyanate, and 2 mol of hydroxyethyl acrylate | |
| Tricyclodecane diacrylate (b) obtained by reacting | 15 parts by mass |
| 1 mol of tolylene diisocyanate and 2 mol of | |
| hydroxyethyl acrylate | |
| N-vinylpyrrolidone | 10 parts by mass |
| Isobornyl acrylate | 10 parts by mass |
| Bisphenol A-ethylene oxide added diol diacrylate | 5 parts by mass |
| 2-Methyl-1-[4-(methylthio)phenyl]-2-morpholino- | 0.7 parts by mass |
| propan-1-one (Irgacure 907, manufactured by Chiba | |
| Speciality Chemicals) | |
| 2,4,6-Trimethylbenzoyldiphenylphosphine oxide | 1.3 parts by mass |
| (Lucirin TPO, manufactured by BASF) | |

Incidentally, in the following Table 1, Test Examples No. 1 to No. 11 are Working Examples and Test Examples No. 12 to No. 16 are Comparative Examples.

TABLE 1

| | Test Example No. | | | | | | | | |
|---|---|---|---|---|---|---|---|---|---|
| | 1 | 2 | 3 | 4 | 5 | 6 | 7 | 8 | 9 |
| Thickness of colored layer (μm) | 10 | 10 | 20 | 20 | 20 | 20 | 20 | 30 | 20 |
| Number of layers of resin coating layer | 2 | 2 | 2 | 2 | 2 | 2 | 2 | 2 | 2 |
| Oligomer species of | a | a | a | a | a | a | a | a | b |
| inner layer | | | | | | | | | |
| Amount of Ti (% by mass) | 1.8 | 1.8 | 1.8 | 1.8 | 0.9 | 0.12 | 0.06 | 1.8 | 0.9 |
| Gel fraction (% by mass) | 80 | 95 | 80 | 85 | 80 | 80 | 78 | 80 | 80 |
| Amount of unreacted initiator (% by mass) | 2 | 0.5 | 2 | 1 | 2 | 2 | 3 | 2 | 2 |
| Linear velocity (m/min.) | 1000 | 500 | 1000 | 750 | 1000 | 1000 | 1000 | 1000 | 1000 |
| Young's modulus of inner layer (MPa) | 0.8 | 1.0 | 0.8 | 0.9 | 0.8 | 0.8 | 0.7 | 0.8 | 0.5 |
| Color peeling | A | A | A | A | A | A | A | A | A |
| Pullout force (kg) | B | A | B | A | B | B | B | B | B |
| Ribbon simultaneous removability | A | A | A | A | A | A | A | A | A |
| Increase in attenuation at low temperature | A | A | A | A | A | A | A | A | A |
| Lateral pressure resistance | B | B | B | B | B | B | B | B | A |

| | Test Example No. | | | | | | | |
|---|---|---|---|---|---|---|---|---|
| | 10 | 11 | 12 | 13 | 14 | 15 | 16 | 17 |
| Thickness of colored layer (μm) | 20 | 20 | 10 | 5 | 5 | 5 | 20 | 20 |
| Number of layers of resin coating layer | 2 | 2 | 2 | 3 | 3 | 2 | 2 | 2 |
| Oligomer species of | c | c | a | a | a | a | c | d |
| inner layer | | | | | | | | |
| Amount of Ti (% by mass) | 0.9 | 1.8 | 0 | 1.8 | 0 | 1.8 | 0 | 1.8 |
| Gel fraction (% by mass) | 80 | 95 | 75 | 85 | 85 | 80 | 75 | 95 |
| Amount of unreacted initiator (% by mass) | 2 | 0.5 | 4 | 1 | 1 | 2 | 4 | 0.5 |
| Linear velocity (m/min.) | 1000 | 500 | 1000 | 1000 | 1000 | 1000 | 1000 | 500 |
| Young's modulus of inner layer (MPa) | 0.05 | 0.15 | 0.6 | 0.9 | 0.9 | 0.8 | 0.03 | 1.2 |
| Color peeling | A | A | A | B | B | B | A | A |
| Pullout force (kg) | C | C | E | A | A | B | E | D |
| Ribbon simultaneous removability | A | A | B | A | A | A | B | B |
| Increase in attenuation at low temperature | A | A | B | A | A | A | B | A |
| Lateral pressure resistance | A | A | B | B | B | C | A | C |

In all of Test Examples No. 1 to No. 11 and No. 17, no color peeling occurred and the degree of curing was also sufficient in the case where the ribbon material (connecting material) of the optical fiber ribbon was stripped to separate into a single optical fiber after the optical fiber ribbon was manufactured. In Test Examples No. 1 to No. 11, individual evaluations of the pullout force, the ribbon simultaneous removability, the increase in attenuation at low temperature, and the lateral pressure resistance were also at acceptable levels.

In Test Examples No. 12 and No. 16, when titanium oxide was not added, the gel fraction of the coating resin was low and the amount of the unreacted initiator was also large. The low gel fraction means that the degree of curing of the resin is insufficient, so that a sufficient pullout force was not obtained and a residue was observed on the glass fiber in the ribbon simultaneous stripping. Since the unreacted initiator is large (more than 3% by mass), it is considered that an increase in attenuation at low temperature was observed.

Test Examples No. 13 and No. 14 are optical fibers having a conventional ink layer. After the inner layer and the outer layer were cured, the ink layer (outermost layer) was applied and cured. Therefore, the gel fraction of the resin coating layer and the amount of the unreacted initiator were at acceptable levels but color peeling of the ink layer occurred.

Test Example No. 15 is an example in which the outer layer was thinned but color peeling occurred similarly to the conventional ink layer.

### DESCRIPTION OF REFERENCE NUMERALS AND SIGNS

10: Optical fiber
11: Core part
12: Cladding part
13: Glass fiber
14: Inner layer
15: Outer layer
16: Resin coating layer
20: Optical fiber ribbon
21: Connecting material

1. An optical fiber comprising a glass fiber and a resin coating layer that covers the outer periphery of the glass fiber, wherein
the resin coating layer has a colored layer having a thickness of 10 μm or more and 0.06 to 1.8% by mass of titanium element is contained in the resin coating layer.

2. The optical fiber according to claim 1, wherein the resin coating layer is formed of an ultraviolet curable resin composition and gel fraction is more than 75% by mass.

3. The optical fiber according to claim 1, wherein the amount of unreacted photoinitiator in the resin coating layer is 3% by mass or less.

4. The optical fiber according to claim 1, wherein the resin coating layer includes an inner layer that coats the outer periphery of the glass fiber and an outer layer that coats the outer periphery of the inner layer and Young's modulus of the inner layer is 0.05 to 1 MPa.

5. An optical fiber ribbon comprising a plurality of the optical fibers according to claim 1 arranged in parallel, the plurality of the optical fibers being connected with a connecting material.
